(19) United States
(12) Patent Application Publication
(10) Pub. No.: US 2005/0193001 A1
(43) Pub. Date: Sep. 1, 2005

(54) Client-side wizard framework

(75) Inventor: Oren Shoham, Hertsliya (IL)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SAP AG, Walldorf (DE)

(21) Appl. No.: 10/863,812

(22) Filed: Jun. 7, 2004

Related U.S. Application Data
(60) Provisional application No. 60/548,449, filed on Feb. 27, 2004.

(51) Int. Cl. G06F 17/30

(52) U.S. Cl. 707/103 R

(57) ABSTRACT

A method for creating a wizard in a client-server environment includes providing a framework at a server in a client-server system, the framework being configured to facilitate creation of a wizard. A request is received from a client for the framework at a server. A data source associated with a wizard to be created is fetched using the framework, the data source being located at a location associated with the server. The framework and the data source are transmitted to the client from the server. Data inputted using the client to fill in the wizard are saved at a location associated with the client and not at a location associated with the server while the wizard is being created at the client.

### CROSS-REFERENCES TO RELATED APPLICATIONS

The present application claims priority to U.S. Provisional Patent Application No. 60/548,449, filed 0 on Feb. 27, 2004, which is incorporated by reference.

### BACKGROUND OF THE INVENTION

The present invention relates to a framework for creating a tool that performs a predefined task.

The Internet has revolutionized the way businesses conduct their businesses. The Internet provides the opportunity for systems to communicate instantly with other systems or individuals. Business processes that were once restricted to intranets and their users are now moving to the Internet. Companies are moving more and more of their data to electronic forms.

In addition, companies have amassed huge amounts of data in an effort to understand their business, improve performance, and build stronger employee, customer, and partner relationships. However, it is difficult to truly exploit that data, i.e., to make sense of it and put it to work across the enterprise. Data are generally scattered across an organization in a variety of systems. These heterogeneous systems include customer relationship management, enterprise resource planning, financial applications, and the like.

For each of these business solution programs, there generally tends to be many vendors. Some large companies may use different vendor products for the same business solution, particularly if there is legacy issues. Also companies may have their own proprietary systems.

In the past, information stored in an application could only be used within the context of that application. In this age of ubiquitous computers, however, businesses must be able to integrate all these heterogeneous system to efficiently run their businesses.

One proposed solution is the use of enterprise portals. Enterprise portals are configured to integrate applications, information, and services. Portal components that are used to retrieve information play an important role in such portals since they provide an easy way of obtaining information. Building such portal components, however, is not an easy task, particularly for those not familiar with certain programming languages, e.g., Java™ or XML.

### BRIEF SUMMARY OF THE INVENTION

Embodiments of the present invention relates to providing a wizard framework that performs most of the wizard generating functions at the client side to minimize load to the server and to provide the developers with more flexibilities. This client-side wizard framework of the present invention is described in a portal context for illustrative convenience. However, this is one of many environments wherein the client-side wizard framework may be implemented. For example, the wizard framework may be implemented in a conventional client-server environment that is not a portal setting.

Although the portals enable users to quickly access and retrieve desired information from multiple sources, the portals tend to have a very complicated environment since many different types of applications and systems are brought under one “umbrella.” The creation of portal presentation components or editors tends to be a complicated process.

The portal generally includes many multi-screen HTML based editors. These editors generally do not have a unified infrastructure and are based on server-based technologies. As a result, they tend to use a language that could not be used in another environment, creating compatibility issues. Also since such a process is server-based, the server needs to be actively involved in generating a wizard, including temporarily storing the data inputted and generated at the client.

The client-side wizard framework is based on a client browser in one embodiment of the present invention. For example, the wizard framework uses Extensible Markup Language (XML), so that it could be used across the web servers and portal platforms. The wizard multi-screen operations are stored in the browser to minimize the load on the web server. In one embodiment, all data are stored in the web browser or at a client side so there is no need to store temporary data in the web server database using special context objects that hold the current stage of the wizard. All wizard stages are stored in the same XML data source in the client browser. That XML data are sent to the web server to be stored at the server side once the wizard operation has been completed.

In one embodiment, a method for creating a wizard in a web-based client-server environment includes providing a framework at a server in a web-based client-server system, the framework being configured to facilitate creation of a wizard; receiving a request from a client for the framework at a server; fetching a data source associated with a wizard to be created using a module associated with the framework, the data source being located at a location associated with the server; and transmitting the framework and the data source to the client from the server, wherein data inputted using the client to create the wizard are saved at a location associated with the client and not at a location associated with the server while the wizard is being created at the client.

In another embodiment, a computer readable medium includes a computer program for generating a wizard. The computer program comprise code for processing a request received from a client for a framework at a server, the framework being configured to facilitate creation of a wizard; code for fetching a data source associated with a wizard to be created using the framework, the data source being located at a location associated with the server; and code for transmitting the framework and the data source to the client from the server, wherein data inputted using the client to create the wizard are saved at a location associated with the client and not at a location associated with the server while the user is inputting data at the client side to complete the wizard.

In yet another embodiment, a system for creating a wizard in a web-based client-server environment includes means for providing a framework at a server in a web-based client-server system, the framework being configured to facilitate creation of a wizard; means for receiving a request from a client for the framework at a server; means for fetching a data source associated with a wizard to be created using a module associated with the framework, the data source being located at a location associated with the server; and means for transmitting the framework and the data source to the client from the server, wherein data inputted using the client to create the wizard are saved at a location associated with the client and not at a location associated with the server while the wizard is being created at the client.

### BRIEF DESCRIPTION OF THE DRAWINGS

FIG. 1A illustrates a client-server system including a presentation layer, an application layer, and a database layer according to one embodiment of the present invention

FIG. 1B illustrates a schematic interactions between the three functional layers of FIG. 1A.

FIG. 2 illustrates an enterprise portal that couples a client to a plurality of information sources according to one embodiment of the present invention.

FIG. 3 illustrates a wizard framework according to one embodiment of the present invention.

FIG. 4 illustrates a wizard created using the wizard framework of FIG. 3 according to one embodiment of the present invention.

FIG. 5 illustrates a pane created using the wizard framework of FIG. 3 according to one embodiment of the present invention.

FIG. 6 illustrates a framework engine of the wizard framework of FIG. 3 according to one embodiment of the present invention.

FIG. 7 illustrates a process for creating a wizard using a wizard framework according to one embodiment of the present invention.

FIGS. 8A-8D illustrate a plurality of panes associated with a wizard framework [correct?] according to one embodiment of the present invention.

FIGS. 9A-9C illustrate a plurality of panes associated with a wizard that has been created using a wizard framework according to one embodiment of the present invention.

### DETAILED DESCRIPTION OF THE INVENTION

Embodiments of the present invention relate to a framework for use in a web-based client-server environment. The framework is used to create wizard-type processes or wizards that are used to collect information from various sources and present the information in user-friendly formats. A developer at a client site creates a wizard by requesting the framework stored in the server site. The server sends the framework including data source, so that the developer may generate a wizard using the framework. Thereafter, the wizard generating processes are performed entirely or mostly at the client. Accordingly, the present wizard framework is referred to as a client-side wizard framework.

In the embodiments disclosed herein, “wizard” refers a tool that supports the user in performing a predefined task by leading the user through that task by requiring the user to input a limited range of inputs. This input includes simply selecting a wizard icon displayed on a screen to launch the wizard. An example of wizard is a portal presentation component that is used to collect and/or display information to a portal user. An example of such portal presentation component is iViews™ used in SAP Enterprise Portal™. In one implementation, the iView is an XML-based presentation component.

As used herein, “framework” refers to reusable designs of all or part of a software system that enables a designer or user to generate a wizard by performing certain guided tasks, e.g., by implementing a set of methods in a JavaScript file. d

The framework may be used to create many different types of wizards having different levels of complexity. One type of wizards is a presentation component that resides in a presentation layer and is configured to retrieve information from a database layer using an application logic (or business logic) residing in the application layer (or business layer). Such present components are referred to as portal components if they are provided in a portal environment.

A portal serves as a gateway to information sources to one or more users. By definition, the portal is provided in a web-based client-server environment or system that distributes the workload of a computer application across a plurality of cooperating computer programs. This type of computing separates user oriented, application, and data management tasks. That is, these three tasks or functions are distributed to different layers: the presentation, application, and database layers. Generally, each layer has one or more software programs dedicated to provide services to their respective layers.

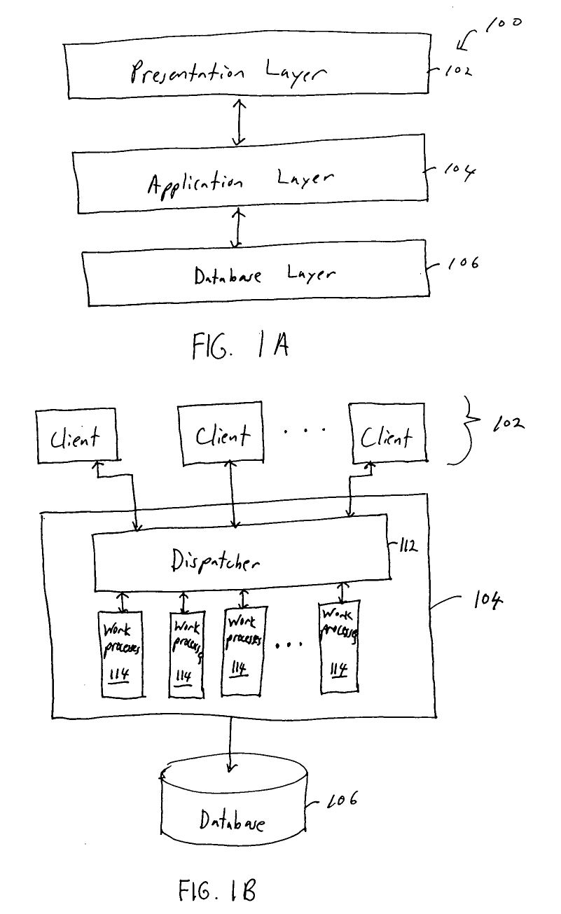

FIG. 1A illustrates a client-server system 100 including a presentation layer 102, an application layer 104, and a database layer 106 according to one embodiment of the present invention. Each layer has one or more servers dedicated to provide functions relating to that layer. The system 100 illustrates a three-tier client-server system; however, a two-tier client-server system or multi-layer cooperative client-server system may also be used to implement the embodiments of the present invention.

The above three layers represent functional groups in the system 100. Each group is configured to support the demands of its functions. The database layer includes database servers that are primarily utilized to read or write data to and from storage locations. These storage locations may be provided in one or more storage subsystems that are linked to the database servers via a communication network, e.g., NAS or SAN. The application layer includes servers that contain the processing logic of the system, including services such as spooling, dispatching user requests, and formatting data. The presentation layer has servers that are primarily configured to perform tasks relating to presentation of the data. Each of these layers generally handle data differently so interfaces are needed to facilitate communication among them. Application layer serves as an intermediary between the presentation and database layers.

FIG. 1B illustrates a schematic interactions between the three functional layers. In the present embodiment, the application layer is implemented using SAP R/3. The application layer receives the data or requests inputted by users using presentation servers. The data received is converted to a format that is compatible with the application logic residing in the application layer. The data is then sent to a dispatcher 112.

The dispatcher is a control program that manages the resources of the applications residing in the application layer. The dispatcher initially keeps the requests in queues and processes them one by one. The dispatcher sends the requests to those work processes 114 that have sufficient resources to handle the request. The work processes are services offered by the application servers (or services requested by a client). The work process executes the received request. This may involve accessing the database layer to retrieve desired data. Once the request has been executed, the work process sends resulting data to the dispatcher that, in turn, forwards it to the presentation server. Thereafter, the data is presented in a user-friendly way at the presentation layer.

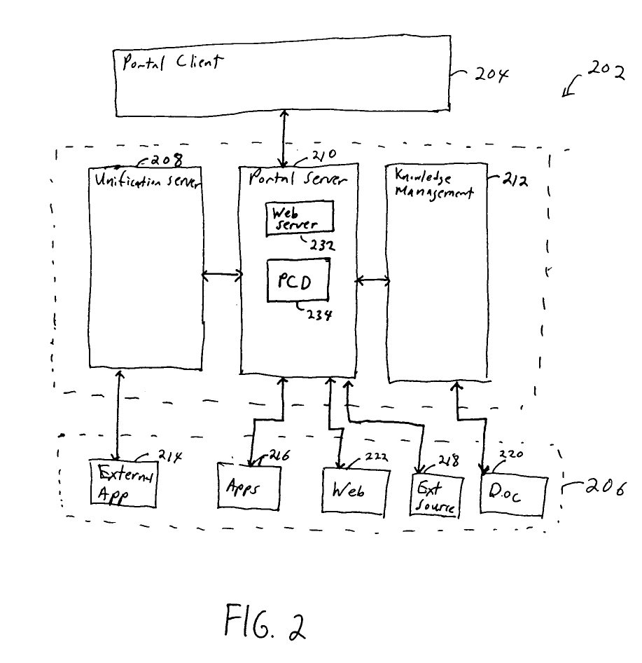

FIG. 2 illustrates an enterprise portal 202 that couples a client 204 to a plurality of information sources 206 according to one embodiment of the present invention. The client 204 may be a personal computer (PC) that is linked to the portal 202 via the Internet, intranet, wide area network, local area network, or the like. The portal is configured to provide users with a common entryway to various applications and information.

In the present embodiment, the portal 202 integrates a plurality of different technologies, enabling users to access applications and information that are both internal and external to the enterprise. The information sources 206 include an external application 214, internal application 206, external document source 218, internal document source 220, and Web 222.

The portal includes a unification server 208, a portal server 210, and a knowledge management 212. The unification server is configured to provide a business unification layer that enables dynamic integration of both applications and information from various sources. The business unification layer enables the creation of a unified object model, so that a portal user may dynamically integrate applications and information. Logical business objects, provided in component systems, are used to create a unification object model that is stored in a repository. The objects are mapped to each other by links, so that users are able to dynamically pass content from one information source to another.

The logical business objects are used to represent a thing, concept, process or event in operation, management, planning or accounting of an organization. Each busines object specify attributes, relationships, and actions/events. For example, the business objects may be used to represent purchase orders, vendors, and users of a system.

The portal server includes a web server 232 that communicates with the client and a portal content directory (PCD) 234 that includes a plurality of presentation components, e.g., iViews. The PCD is a file-based directory that also includes roles and the systems with which the portal is to interact. In one implementation, the PCD runs on a Java 2 Enterprise Edition™-complicatnt application server.

The knowledge management (KM) 210 is a set of services for managing knowledge and collaboration. The KM 210 provides a platform to harmonize various business tools under one business management platform regardless of the physical location of data. In one implementation, the KM includes a repository framework that manages the content of documents and corresponding document attributes, classification engine that organizes contents in folder or tree structures, and other components for managing information.

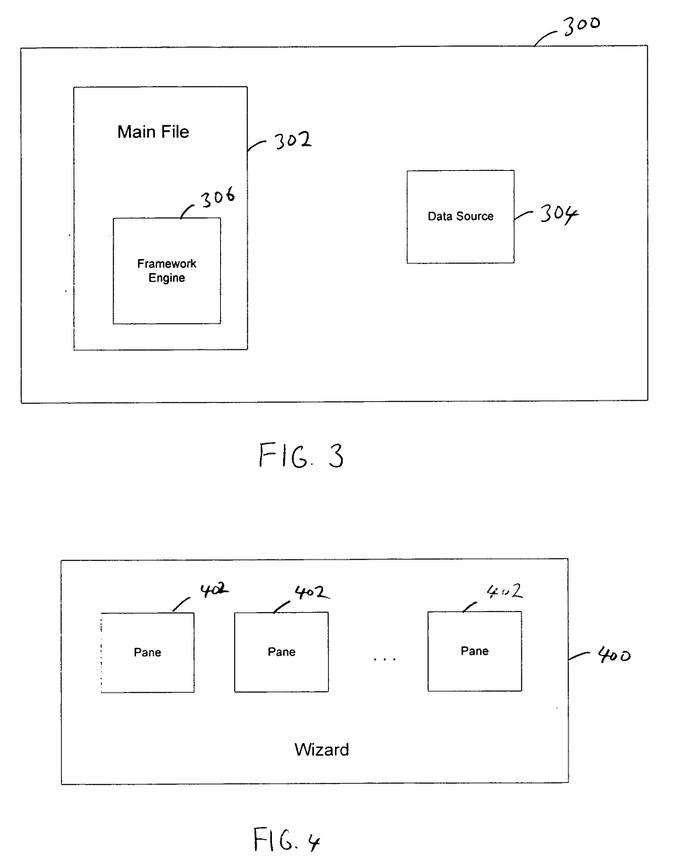

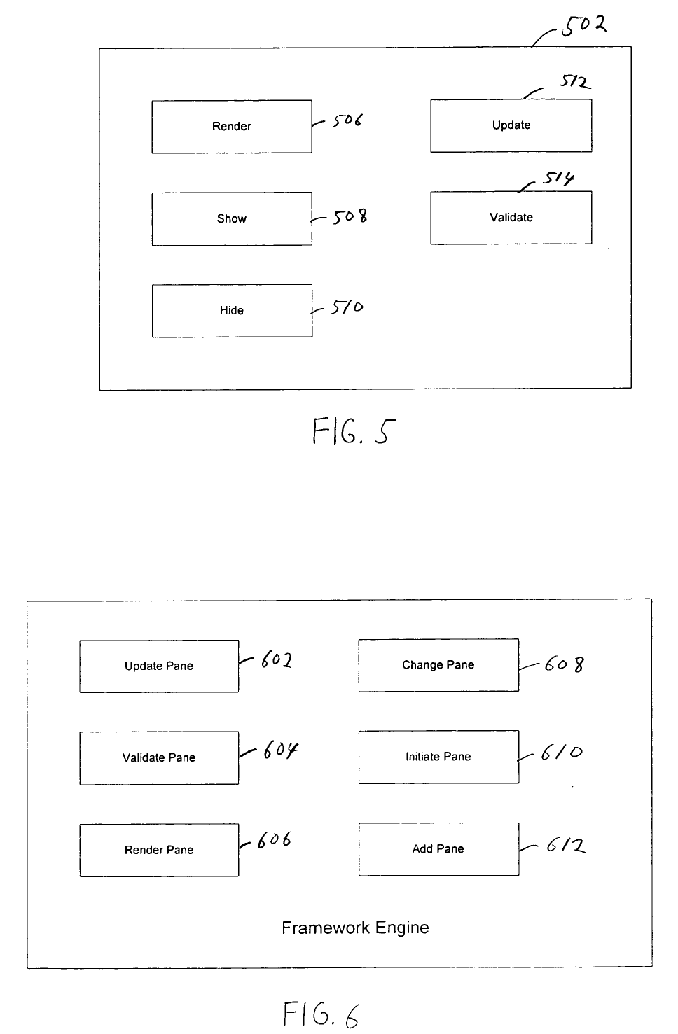

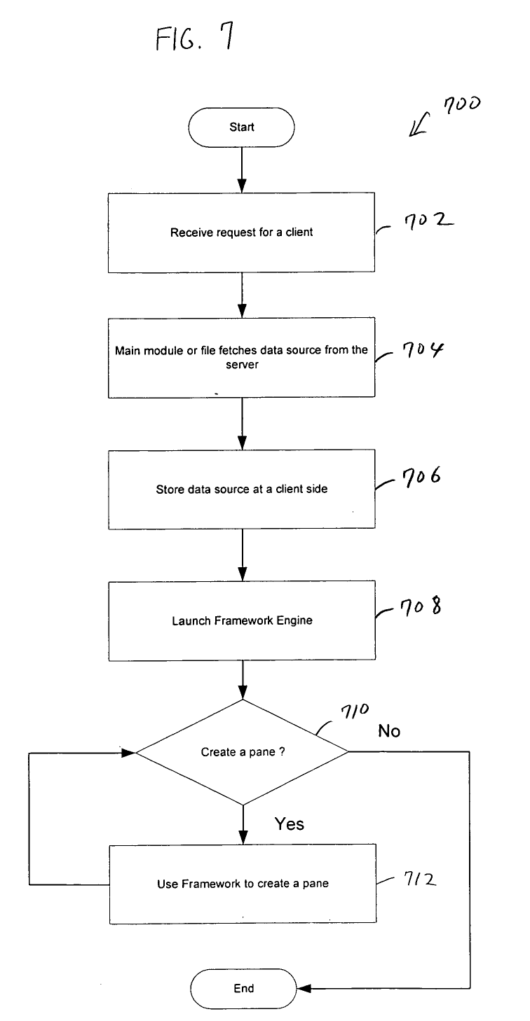

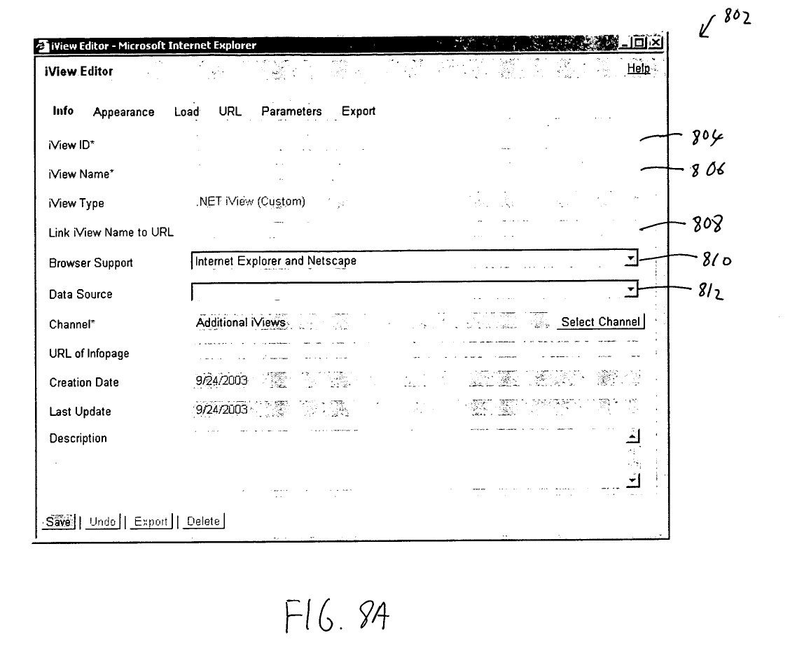

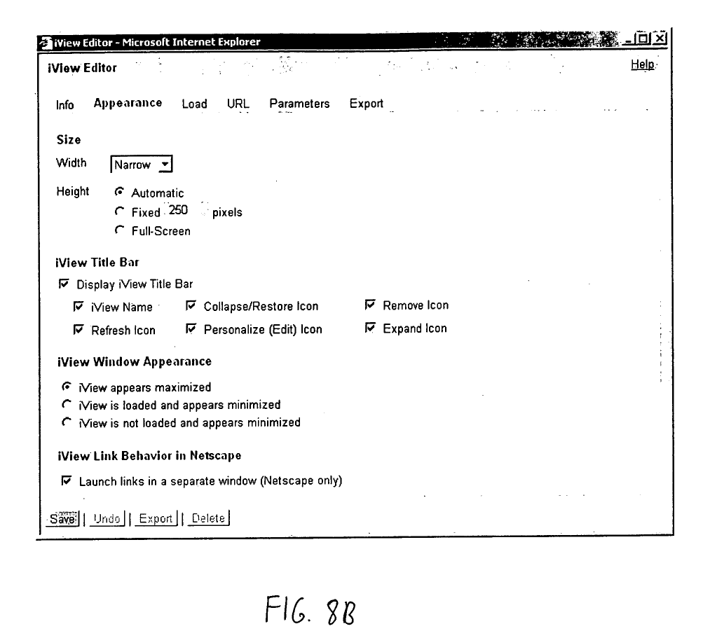

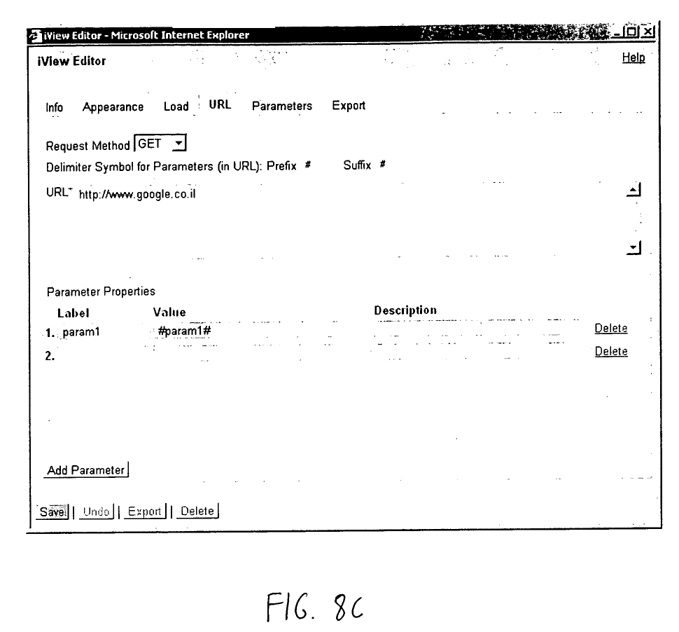

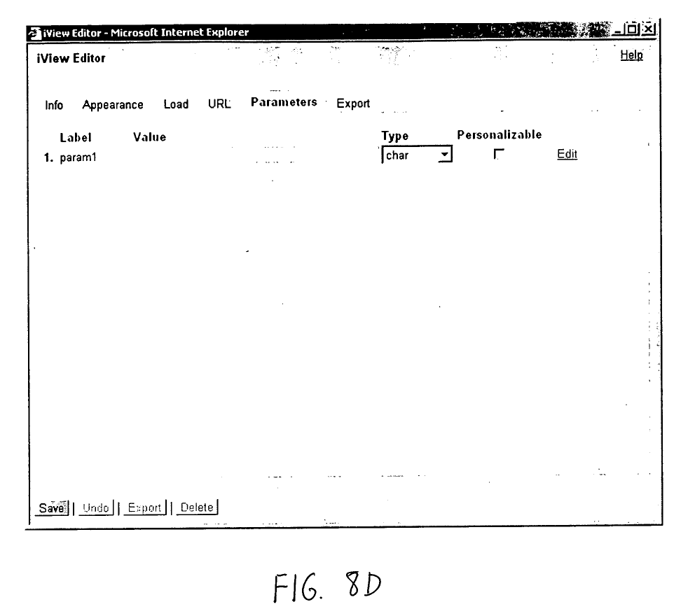

FIG. 3 illustrates a client-side wizard framework 300 according to one embodiment of the present invention. The framework 300 includes a main file or module 302 and a data source 304. The main file 302 fetches the data source from the server when the server receives a request from a client. Thereafter, once the wizard has been generated at the client side, the main file saves the data source back to the server and creates a content area where the wizard is displayed. That is, the main file saves the data source back to the server once the wizard has been completed. In one embodiment, the main file preferably is a file that can be interpreted by the web server, e.g., ASP file, JSP file, servlet, or the like.

The data source 304 relates to the data for the wizard. That is, the data source is data that is used to retrieve desired information for the wizard. For example, to create a wizard relating to sales order for a given company, the data source is the data that is used to retrieve the sales order, so that it can be processed by the wizard, and the data is the sales order information itself. In one embodiment, the data source is in XML and is stored in an XML island in the client browser by the main file. Other formats may be used in other embodiments.

The main file 302 includes a framework engine or manager 306. The framework engine 306 controls the wizard behavior and determines its appearance. The engine is in charge of saving the changes made in a current pane and rendering the user interface of the next pane.

FIG. 4 illustrates an exemplary wizard 400 including a plurality of panes 402 that are generated using the framework 300. The wizard 400 may include a transitional logic that defines how the panes are to be displayed to the users.

FIG. 5 illustrates a pane 502 for the wizard 400 according to one embodiment of the present invention. In the present embodiment, the pane object is a Java Script file and needs some basic functions. That is, the framework engine 306 requires each pane created by the framework 300 to have a plurality of functions. A render function 506 creates the pane content based on the data in the wizard data source and the fields required for the pane. In one implementation, this is done by applying Extensible Stylesheet Language Transformations (XSLT) to the XML data source.

A show function 508 displays the pane content created by the render function 506, so that the user could see the output on the screen. The show function is needed since the render function merely transforms the XML to HTML code and does not display the resulting values. A hide function 510 removes the pane content from the user interface.

An update function 512 updates the pane content in the XML island. For example, the update function retrieves the data that have been changed for a given pane and saves them in the XML island. The data that have been changed generally are data that has been input by a user at the client side to create or define the wizard. A validate function 514 determines whether or not the user inputs are proper.

FIG. 6 illustrates the framework engine 306 according to one embodiment of the present invention. The framework engine 306 includes a plurality of application program interfaces (APIs). An update pane API 602, e.g., updatePanes( ), calls the update function 506, e.g., update( ) function, of each pane object that is registered in the engine 306. All panes for a given wizard is registered with the engine 306, so that they would be operable. Below is an exemplary update pane API.

function updatePanes( )
{

for(p=0;p<paneCollection.length; p++)
{

paneCollection[p].update( );

}

}

A validate pane API 604, e.g., validatePanes ( ), calls the validate function, e.g., validate( ) function, of each pane object that is registered with the engine 306. Below is an exemplary validate pane API.

function validatePanes( )
{

validated=true;
for(p=0;p<paneCollection.length; p++)
{

if(!paneCollection[p].validate( ))
{

return false;

}

}
return true;

}

A render pane API 606, e.g., renderPanes( ), calls the render function 506, e.g., render( ) function, of each pane object that is registered with the engine. Below is an exemplary render pane API.

function renderPanes( )
{

for(j=0;j<paneCollection.length; j++)
{

paneCollection[j].render( );

}

}

A change pane API 608, e.g., changePane(pane), updates and hides the previous pane and shows a new pane in replace of the previous pane. Below is an exemplary change pane API.

function changePane(pane)
{

if(pane.index==idxSel && currentPane) return;
if(currentPane)
{

currentPane.update( );
currentPane.hide( );

}
sapTbs_switch(pane.index)
currentPane=pane;
pane.show( );

}

An initiate pane function 610 of the framework renders all the panes for the wizard and changes a pane to the given pane object. Below is an exemplary initiate pane function.

function initPanes(initialPane)
{

currentPane=document.all.emptyPane;
renderPanes( );
changePane(initialPane);

}
function initFunctions(pane)
{

| | |
|---|---|
| pane.render | = eval(pane.id + ‘Render’); |
| pane.hide | = eval(pane.id + ‘Hide’); |
| pane.update | = eval(pane.id + ‘Update’); |
| pane.show | = eval(pane.id + ‘Show’); |

pane.validate = eval(pane.id + ‘Validate’)

}

An add pane 612 adds or registers a new pane object to the framework engine. Below is an exemplary add pane API.

function addPane(paneName, paneTitle)
{

pane = document.createElement(“DIV”)
pane.id = paneName;
initFunctions(pane);
pane.style.display=“none”;
paneIndex = paneCollection.length;
pane.index = paneIndex;
paneCollection[paneIndex]=pane;
drawPane(paneTitle, paneName, paneIndex

}

FIG. 7 illustrates a process 700 for generating a wizard using a client-side wizard framework according to one embodiment of the present invention. The process 700 is explained in the portal context as illustrated in FIG. 2 for illustrative convenience. At step 702, the client 204 sends a request to the portal server 210 for a client-side wizard framework. The wizard framework 300 of FIG. 3 is an example of one such a framework. This request step involves entering the URL of the main file in the browser according to one embodiment of the present invention. Alternatively, this request step may be performed by selecting an icon representing the framework.

In response to the request, the main module or file fetches a data source needed for a given wizard to be generated from the PCD (step 704). The data source may also be fetched from a database, the World Wide Web, or the like. The main module resides at the server or portal side. The main module may fetch a default data source or fetch a data source identified by the user. As used herein, the term “server side” or “portal side” refers to locations not associated with the client 204. Accordingly, the server or portal side include the portal 202 and information sources 206.

The main module stores the retrieved data source at a client side (step 706). In one embodiment, the data source is stored in an XML island of the client browser. The main module is also transmitted to the client 204. The main module includes a framework engine that is used to create the panes that are needed for the wizard to be created. The framework engine is launched at the client to start creating a pane for the wizard (steps 708 and 710).

A pane is created using the pane APIs described above, e.g., the update pane API 602, validate pane API 604, and the like (step 712). A next pane is created if needed. Otherwise, the process ends. Each pane created includes one or more functions described in connection with FIG. 5. In one embodiment, each pane includes all five functions, i.e., render, show, hide, update, and validate. In another embodiment, each pane may not have all these five separate functions, e.g., one or more functions may be integrated.

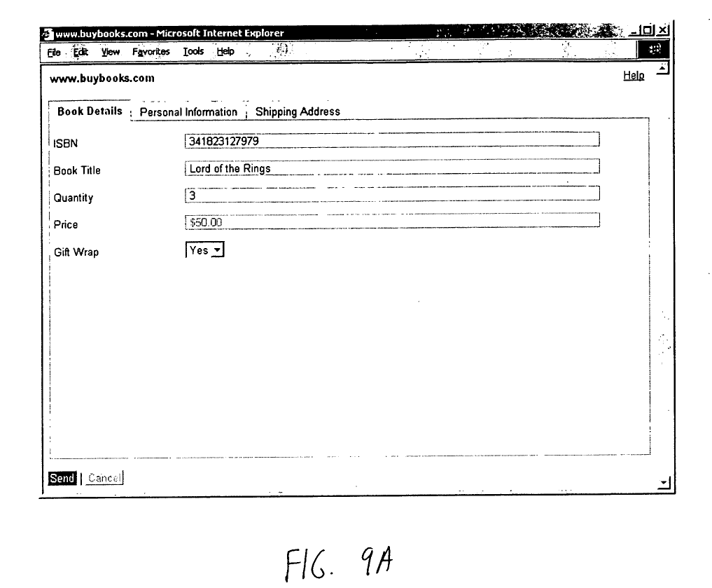

FIGS. 8A-8D illustrate an iView editor for SAP Enterprise Portal 5.0™, which is a wizard that has been created using the client-side wizard framework according to one embodiment of the present invention. This wizard uses the framework underlying the engine to edit iViews, which is a portal snippet that is used to retrieve information residing in a portal. Each iView generally includes a query portion to retrieve data and a presentation component to present the retrieve date to a user. FIG. 8A illustrates an information pane 802 that is used to define an iView to be created using the framework. An iView ID field 804 is used to input a unique name for the iView to be created. An iView Name field 806 is used to input a descriptive name that is used to refer to the iView to be created. This name does not have to be unique. A Link field 808 is used to link the iView to a Universal Resource Locator. A browser support field 810 is a specific field for the iView editor. A data source 812 is used to identify the data source for the iView.

FIG. 8B illustrates an appearance pane that is used to define the appearance of the iView. FIG. 8C illustrates an URL pane relating to the source URL of the iView. FIG. 8D illustrates a parameters pane to provide the parameters of the URL of the iView.

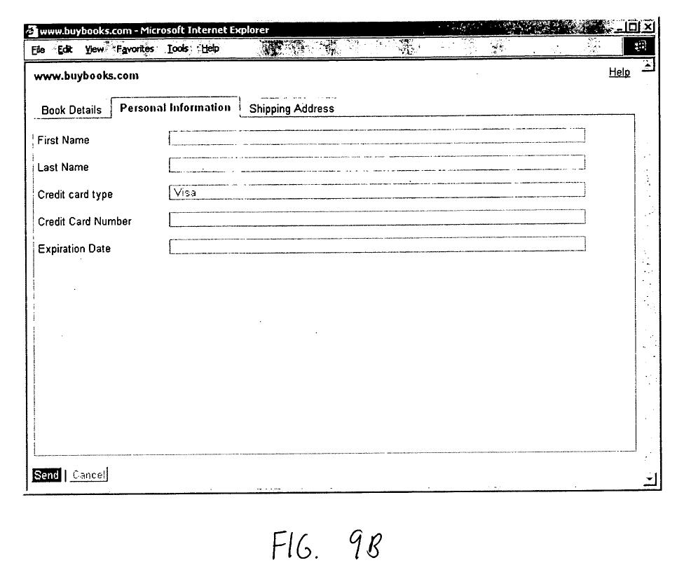

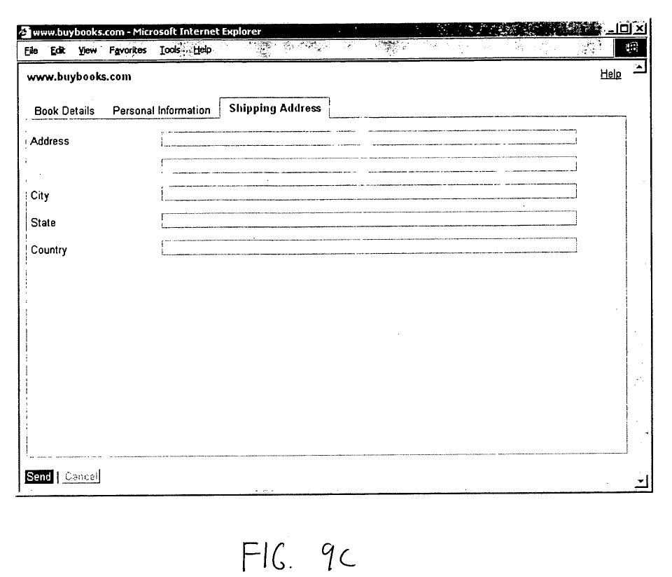

FIGS. 9A to 9C illustrate a book-order wizard created using a client-side wizard framework according to one embodiment of the present invention. FIG. 9A illustrates a book-details pane that is used to identify a book that the user wishes to order. FIG. 9B illustrates a personal-information pane that is used to input the user information. FIG. 9C illustrates a shipping-address pane that is used to input the address to where the book is to be delivered.

The present invention has been described using the above specific embodiments. The scope of the invention shall be defined by the appended claims.

1. A method for creating a wizard in a web-based client-server enviroment, the method comprising:
providing a framework at a server in a web-based client-server system, the framework being configured to facilitate creation of a wizard;
receiving a request from a client for the framework at a server;
fetching a data source associated with a wizard to be created using a module associated with the framework, the data source being located at a location associated with the server; and
transmitting the framework and the data source to the client from the server,
wherein data inputted using the client to create the wizard are saved at a location associated with the client and not at a location associated with the server while the wizard is being created at the client.

2. The method of claim 1, wherein all data input at a client side using the client to create the wizard are save entirely at the client side.

3. The method of claim 2, wherein there is no need to store temporary data generated at the client to create the wizard in a location associated with the server.

4. The method of claim 1, wherein the data source is stored in a location associated with a browser running on the client.

5. The method of claim 4, wherein the data source is stored in an Extensible Markup Language (XML) island of the browser.

6. The method of claim 1, wherein the wizard is created at a client side without any interaction with the server once the framework and data source have been received from the server.

7. The method of claim 6, further comprising:
at the server, receiving the data inputted at the client to create the wizard, the received data being suitable to create a wizard having a plurality of panes; and
storing the data received from the client at a location associated with the server.

8. The method of claim 1, wherein the server is a portal.

9. The method of claim 1, wherein the creation of the wizard at the client includes completing a plurality of wizard stages, wherein all data input at the client to complete the wizard stages are stored at the client until the user has finished entering data for the wizard.

10. The method of claim 9, wherein the all data input at the client to complete the wizard stages are stored in the same location where the data source is stored.

11. The method of claim 9, wherein the location where the data source is stored is a location associated with a browser running on the client.

12. The method of claim 1, wherein the wizard is created based on a browser technology.

13. A computer readable medium including a computer program for generating a wizard, the computer program comprising:
code for processing a request received from a client for a framework at a server, the framework being configured to facilitate creation of a wizard;
code for fetching a data source associated with a wizard to be created using the framework, the data source being located at a location associated with the server; and
code for transmitting the framework and the data source to the client from the server,
wherein data inputted using the client to create the wizard are saved at a location associated with the client and not at a location associated with the server while the user is inputting data at the client side to complete the wizard.

14. A system for creating a wizard in a web-based client-server environment, the system comprising:
means for providing a framework at a server in a web-based client-server system, the framework being configured to facilitate creation of a wizard;
means for receiving a request from a client for the framework at a server;
means for fetching a data source associated with a wizard to be created using a module associated with the framework, the data source being located at a location associated with the server; and
means for transmitting the framework and the data source to the client from the server,
wherein data inputted using the client to create the wizard are saved at a location associated with the client and not at a location associated with the server while the wizard is being created at the client.
